(19) United States
(12) Patent Application Publication
(10) Pub. No.: US 2012/0026918 A1
(43) Pub. Date: Feb. 2, 2012

(54) METHOD AND SYSTEM OF MANAGING NEIGHBOR RELATION TABLE IN WIRELESS COMMUNICATION SYSTEM HAVING SELF-ORGANIZING NETWORK FUNCTION

(75) Inventors: Jeong Jae Won, Gyeonggi-do (KR); Hee Jung Byun, Gyeonggi-do (KR); Young Seok Kim, Gyeonggi-do (KR); Mi Sun Do, Gyeonggi-do (KR); Hong Koo Kang, Gyeonggi-do (KR); Il Won Kwon, Gyeonggi-do (KR); Seung Cheol Mun, Gyeonggi-do (KR); Dong Seop Lee, Gyeonggi-do (KR); Jung Hee Han, Gyeonggi-do (KR); Hwa Jin Cha, Gyeonggi-do (KR); Jung Min So, Gyeonggi-do (KR)

(73) Assignee: SAMSUNG ELECTRONICS CO., LTD., Suwon-city, Gyeonggi-do (KR)

(21) Appl. No.: 13/201,327

(22) PCT Filed: Feb. 11, 2010
(86) PCT No.: PCT/KR2010/000881

§ 371 Date: Oct. 24, 2011

(30) Foreign Application Priority Data
Feb. 13, 2009 (KR) 10-2009-0011890

(51) Int. Cl. H04W 84/18

(52) U.S. Cl. 370/255

(57) ABSTRACT

Provided is a method of managing a neighbor relation table by a base station in a wireless communication system having a self-organizing network function, which includes receiving a neighbor base station report from a terminal; comparing the neighbor base station report with a stored neighbor relation table; calculating a statistic value of a new base station when the new base station is present in the comparison step; and adding the new base station to the stored neighbor relation table when the statistic value is equal to or greater than a first reference value.

### TECHNICAL FIELD

The present invention relates to a wireless communication system, and more particularly, to a method of automatically managing a neighbor relation table (NRT) in a wireless communication system having a self-organizing network (SON) function and a system thereof.

### BACKGROUND ART

Universal Mobile Telecommunication Service (UMTS) systems are a third generation asynchronous mobile telecommunication system using Wide band Code Division Multiple Access (WCDMA) based on Global System for Mobile Communications (GSM) and General Packet Radio Services (GPRS). Third Generation Partnership Project (3GPP) in charge of UMTS standard is discussing Long Term Evolution (LTE) as a next generation wireless communication system of the UMTS systems. The LTE is a technology of implementing high-speed packet based communication with transmission speed of approximately maximum 300 Mbps, and aims to be used commonly in year 2010. There have been many attempts to do this. For example, there is an attempt to reduce the number of nodes located on a communication line by simplifying a structure of a network or an attempt to approach the wireless protocols to a wireless channel as far as possible. In the meantime, a SON for base station management aims at constructing a network more stably and efficiently. In particular, with visualization in introduction of Femto cells and next generation 4G in a wireless communication system field, there is growing interest in an SON with an automation function such as self-configuration or self-optimization. Nodes such as the Femto cells are not installed at an optimal position designated by a service provider but are installed by a user. Accordingly, cell planning for the nodes can not be performed. The nodes themselves detect the environment and collect information to perform optimization.

Accordingly, in this case, the SON may be defined as a network that enables nodes to access/set a network by themselves, and to suitably perform cell optimization and operation according to a peripheral wireless environment when installing the nodes indoors and outdoors. However, since parts capable of applying a self-organizing function are very diverse in a field of a wireless communication system, the SON can be differently defined according to characteristics, types, and objects of a network to be self-organized. In addition to a configuration of the network, self-organizing concept is applicable to a individual management algorithm and optimization. In spite of the foregoing requirements, there has not been proposed a specific method of managing neighbor base stations and system thereof.

The present invention has been made in view of the above problems, and provides a method of automatically managing an NRT in a wireless communication system having an SON function using adding and removing algorithm of the NRT according to the cases which can be occurred in base station management in a network manager, and a system thereof.

In accordance with an aspect of the present invention, a method of managing a neighbor relation table by a base station in a wireless communication system having a self-organizing network function includes: receiving a neighbor base station report from a terminal; comparing the neighbor base station report with a stored neighbor relation table; calculating a statistic value of a new base station, in case it is determined that the new base station exists in the step of comparing the neighbor base station report; and adding the new base station to the stored neighbor relation table when the statistic value is equal to or greater than a first reference value. The method further includes, after adding the new base station, calculating a statistic value of a base station included in the stored neighbor relation table except for the new base station; and removing base stations equal to or greater than a second value from the stored neighbor relation table when the statistic value is equal to or greater than the second value.

In the method of automatically managing an NRT in a wireless communication system having an SON function, a base station, and a system thereof, since a network may be configured more stably or efficiently in an SON, total service quality may be improved.

### BRIEF DESCRIPTION OF DRAWINGS

The objects, features and advantages of the present invention will be more apparent from the following detailed description in conjunction with the accompanying drawings, in which:

FIG. 1 is a concept diagram illustrating a wireless communication system according to an exemplary embodiment of the present invention;

FIG. 2 is a view illustrating an NRT stored in a base station in a wireless communication system according to an exemplary embodiment of the present invention;

FIG. 3 is a block diagram illustrating a configuration of a network manager and a base station in a wireless communication system according to an exemplary embodiment of the present invention;

FIG. 4 is a block diagram illustrating a configuration of a network manager and a base station in a wireless communication system according to another exemplary embodiment of the present invention; and

FIG. 5 is a flowchart illustrating a method of managing an NRT in a wireless communication system according to another exemplary embodiment of the present invention.

### MODE FOR THE INVENTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

Terms of an embodiment of the present invention are based on a 3GPP LTE system standard.

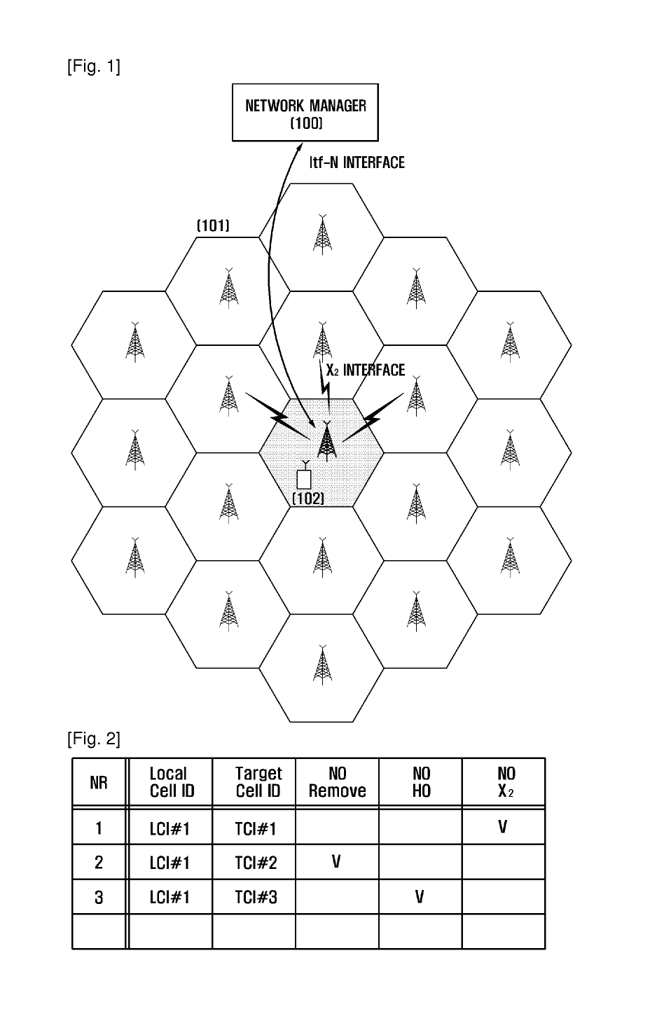

FIG. 1 is a concept diagram illustrating a wireless communication system according to an exemplary embodiment of the present invention.

Referring to FIG. 1, the wireless communication system according to an exemplary embodiment of the present invention includes a network manager 101, a plurality of cell areas 101, and a terminal 102. In particular, the plurality of cell areas 101 includes a base station for controlling each cell. The network manager 100 includes an SON server. The network manager 101 communicates with respective base stations for controlling the plurality of cell areas 101 using a 1 tf-N interface. In particular, the network manager 101 and the respective base stations exchange information for managing an NRT. In detail, a base station reports a list of neighboring base stations to the network manager 100. Upon reception of the list of neighboring base stations, the network manager 100 performs given procedures, and transmits a command of adding or removing specific base stations to or from the NRT stored in the base station. Meanwhile, the terminal 102 transmits information regarding base stations for controlling cell areas except for a cell area to which the terminal 102 belongs to a base station for controlling the cell area. Such information transmission is achieved in a form of radio resource control (RRC) messages. Each base station for controlling the plurality of cell areas 101 receives base station operation and management (OAM) information from the network manager 100 or a separate OAM server, and uses it as management information of the NRT. Communication environment information is transmitted and received between base stations through an X2 interface.

FIG. 2 is a view illustrating a neighbor relation table stored in a base station in a wireless communication system according to an exemplary embodiment of the present invention.

Referring to FIG. 2, the NRT stored in a base station in the wireless communication system according to an exemplary embodiment of the present invention includes fields about a self cell ID and a target cell ID, and a removal impossible attribute, a handover impossible attribute, and an X2 interface attribute as attributes corresponding to each field. The following is a detailed explanation of each attribute. The removal impossible attribute indicates not to remove base stations with high occurrence possibility of hand-over event closely associated with the base station itself from the NRT although they satisfy the following specific conditions. The hand-over impossible attribute is an attribute of base stations with high possibility to be removed from the NRT without an occurrence possibility of a hand-over event that are even registered as a neighbor base station. The X2 interface attribute is an attribute for indicating presence of an X2 interface being an interface between base stations, and indicates that information exchange is not achieved between base stations not connected by the X2 interface.

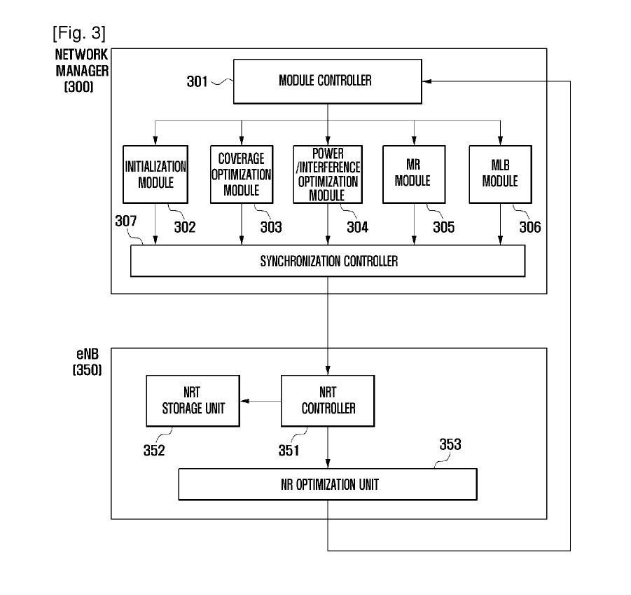

FIG. 3 is a block diagram illustrating a network manager and a base station in the wireless communication system according to an exemplary embodiment of the present invention.

Referring to FIG. 3, the wireless communication system according to an exemplary embodiment of the present invention includes a network manager 300 and a base station (eNB) 350. The network manager 300 may include a module controller 301, an initialization module 302, a coverage optimization module 303, a power/interference optimization module 304, a mobility robustness (MR) module 305, a mobility load balancing (MLB) module 306, and a synchronization controller 307. The base station (eNB) 350 may include an NRT controller 351, an NRT storage unit 352, and an NR optimization unit 353. In the network manager 300, the module controller 301 transmits collected network quality information itself or network quality information received from a base station to necessary modules. The initialization module 302 creates and transmits new set information of a base station and changed set information of a neighbor base station to the synchronization controller 307. The coverage optimization module 303 creates change information for system set for maximizing a capacity of a base station. The power/interference optimization module 304 optimizes power consumption of the base station to create set information of a neighbor base station, and transmits it to the synchronization controller 307. Further, the MR module 305 optimizes hand-over to create base station set information. The MLB module 306 optimizes a balance of a processing load between base stations to create base station set information. The synchronization controller 307 determines whether to change an NRT stored in each station using the base station set information received from the respective modules, and transmits the NRT change presence information to the NRT controller 351 of the base station.

Hereinafter, a configuration of the base station 350 will be described. The NRT controller 351 adds or removes a base station to or from the NRT stored in the NRT storage unit 352 using the NRT change presence information received from the network manager 300. The NR optimization unit 353 optimizes transmitting/receiving signals with a neighbor base station based on information regarding adding or removing of the base station to or from the NRT from the NRT controller 351, and transmits the optimization information to the network manager 300.

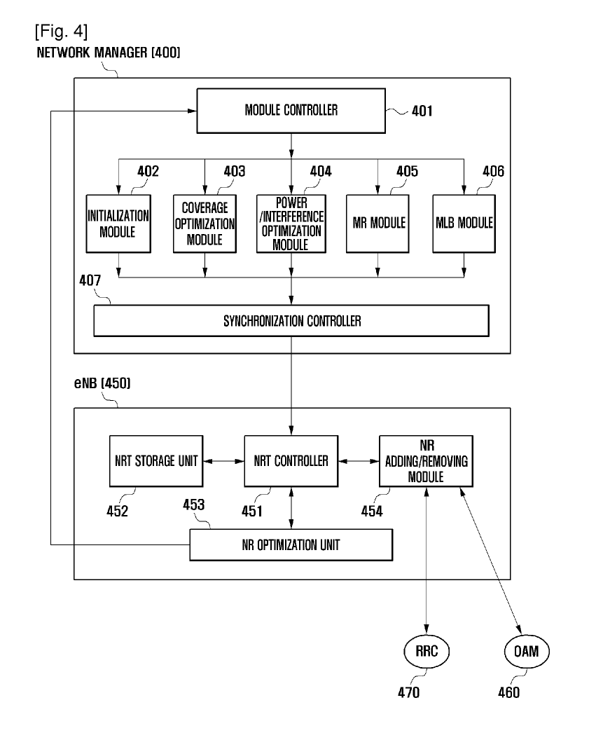

FIG. 4 is a block diagram illustrating a network manager and a base station in the wireless communication system according to another exemplary embodiment of the present invention.

Referring to FIG. 4, the wireless communication system according to another exemplary embodiment of the present invention includes a network manger 401 and a base station 450. A construction of the network manager was described above, and thus the detailed description is omitted. The base station (Enb) 450 in the wireless communication system according to another exemplary embodiment of the present invention further includes a NR adding/removing module 454 besides an NRT controller 451, an NRT storage unit 452, an NRT optimization unit 453.

Functions of the NR adding/removing module 454 will be explained in detail below. The NR adding/removing module 454 receives self-cell coverage information and cell coverage information of neighbor base stations from a terminal through an RRC message 470. Meanwhile, the NR adding/removing module 454 may receive the foregoing information from an operation and management (OAM) server. Upon reception of the information, the NR adding/removing module 454 determines to add or remove neighbor base stations to or from the NRT using the RRC message and the OAM information. In particular, the NR adding/removing module 454 calculates the reported number of quality information in the neighbor base stations, the failure number of hand-over to a neighbor base station, and a radio link failure (RLF) through the RRC message and the OAM information, and uses them as upgrade information of the NRT. The following is an explanation of a case considering the reported number of quality information in the neighbor base stations. When an event regarding the neighbor base stations occurs, the terminal reports quality information of all base stations among the neighbor base stations having signal quality greater than a reference value to the NR adding/removing module 454. Accordingly, the NR adding/removing module 454 determines to add or remove neighbor base stations based on the quality information of all base stations to transmit a base station removing command to the NRT controller 451. The NRT controller 451 reports changed NRT information to the network manager.

Next, a case of considering the failure number of hand-over to a neighbor base station is described herein. A base station collects failure information of hand-over to a neighbor base station over a constant period of time. Further, the base station calculates a statistic value of a hand-over failure rate regarding the neighbor base station through the collected information. When the statistic value is less than or equal to a threshold value, the base station transmits a base station removing command for removing a neighbor base station from the NRT to the NRT controller 451. The NRT controller 451 reports changed NRT information to the network manager. Finally, a case of considering the rate of a radio link failure is explained. The base station collects failure information of a radio link set to a neighbor base station from the terminal or the OAM server regardless of hand-over event occurrence. Moreover, the base station calculates a statistic value of a radio link set failure regarding the neighbor base station through the collected information. When the statistic value is less than or equal to the threshold value, the base station transmits a base station removing command for removing a neighbor base station from the NRT to the NRT controller 451. The NRT controller 451 reports changed NRT information to the network manager.

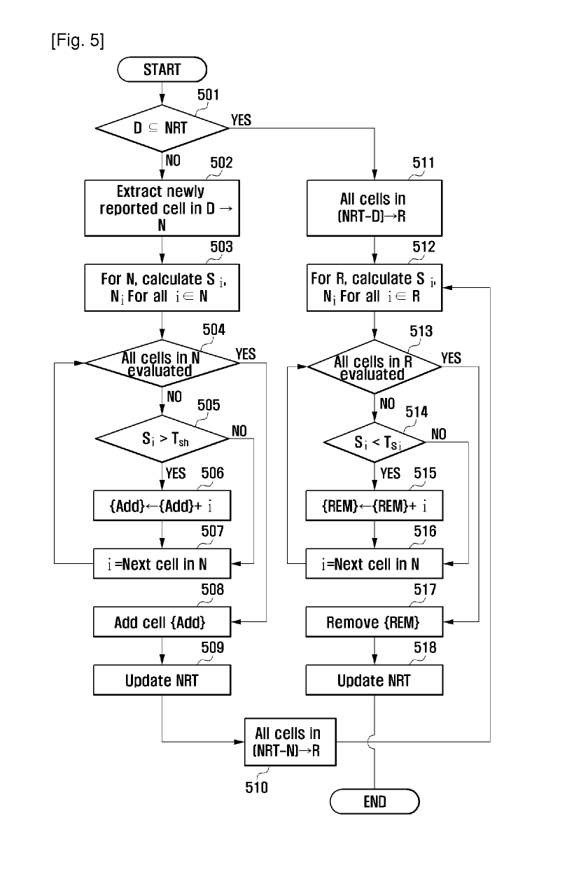

FIG. 5 is a flowchart illustrating a method of managing an NRT in the wireless communication system according to another exemplary embodiment of the present invention. The following is a description of a method of managing the NRT in a wireless communication system based on an operation of the NRT controller in a base station according to the embodiment.

Referring to FIG. 5, D refers to a set of base stations included in a neighbor base station report received from a terminal. A base station determines whether D is included in an NRT (501). When the D is not included in the NRT at step 501, i.e., when it is determined that new base stations are included in the D, the base station allocates the new base stations to a set N (502). A statistic value Sᵢ of all base stations included in the set N is calculated (503). Next, it is determined whether the new base stations are added to all base stations of the set N (504). The statistic value Sᵢ of a base station i included in the set N is compared with a reference value Tₛₕ (505). When it is determined that the statistic value Sᵢ of a base station i is greater than the reference value Tₛₕ at step 505, the base station adds the base station i to a base station addition list {ADD} (506), and allocates another base station among the base stations included in the N to the base station i (507).

Then, when it is determined that the new base stations are added to all base stations of the set N at step 504, the base station executes a command of adding the base station addition list {ADD} to the NRT (508), and updates the NRT (509) and reports it to a network manager. The base station allocates base stations except for base stations included in the set N among base stations of the NRT to a removal determination target base station set R (510).

When the D is included in the NRT in step 501, the base station allocates base stations except for base stations included in the set D among base stations of the NRT to the removal determination target base station set R (511). Further, a statistic value Sᵢ of all base stations included in the set R is calculated (512). Next, it is determined whether or not the new base stations are removed from all base stations of the set N (513). The statistic value Sᵢ of a base station i included in the set R is compared with a reference value Tₛ₁ (514). When it is determined that the statistic value Sᵢ of a base station i is less than the reference value Tₛ₁ at step 514, the base station adds the base station i to a base station removal list {REM} (515), and allocates another base station among the base stations included in the R to the base station I (516).

Then, when it is determined that the new base stations are removed from all base stations of the set N at step 513, the base station executes a command removing the base station removal list {REM} from the NRT (517), and updates the NRT (518) and reports it to a network manager.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

1. A method of managing a neighbor relation table by a base station in a wireless communication system having a self-organizing network function, comprising: receiving a neighbor base station report from a terminal; comparing the neighbor base station report with a stored neighbor relation table; calculating a statistic value of a new base station, in case it is determined that the new base station exists in the step of comparing the neighbor base station report; and adding the new base station to the stored neighbor relation table when the statistic value is equal to or greater than a first reference value.

2. The method of claim 1, after adding the new base station, further comprising: calculating a statistic value of a base station included in the stored neighbor relation table except for the new base station; and removing base stations equal to or greater than a second value from the stored neighbor relation table when the statistic value is equal to or greater than the second value.

3. The method of claim 1, further comprising: calculating a statistic value of a base station included in the stored neighbor relation table except for base stations included in the neighbor base station report, in case it is determined that the new base station does not exist in the step of comparing the neighbor base station report; and removing base stations equal to or greater than a second value from the stored neighbor relation table, in case the statistic value is equal to or greater than the second value.

4. The method of claim 1, wherein the statistic value is channel state information between the base station and a neighbor base station.

5. A wireless communication system, comprising: a terminal which receives information for base stations neighboring a serving base station and transmits a neighbor base station report to the serving base station; and a serving base station which comprises a storage unit for storing a neighbor relation table, a neighbor relation table controller for controlling presence of update in the neighbor relation table, and a neighbor relation adding/removing module for receiving the neighbor base station report from the terminal, and creating and transmitting a base station adding command and a base station removing command to the neighbor relation table controller.

6. The wireless communication system of claim 5, wherein the neighbor relation adding/removing module transmits update presence information of the neighbor relation table to the neighbor relation table controller of the base station using interference information and handover success rate information between the serving base station and neighbor base stations.

7. The wireless communication system of claim 6, wherein the neighbor relation adding/removing module receives the neighbor base station report, compares the neighbor base station report with the neighbor relation table, calculates a statistic value of a new base station in case it is determined that the new base station exists, and creates and transmits the base station adding command to the neighbor relation table controller when the statistic value is equal to or greater than a first reference value.

8. The wireless communication system of claim 7, wherein the neighbor relation adding/removing module calculates a statistic value of a base station included in the stored neighbor relation table except for the new base station, and creates and transmits a base station removing command for removing base stations equal to or greater than a second value from the stored neighbor relation table to the neighbor relation table controller when the statistic value is equal to or greater than the second value.

9. The wireless communication system of claim 7, wherein, in case it is determined that the new base station does not exist, the neighbor relation adding/removing module calculates a statistic value of a base station included in the stored neighbor relation table except for base stations included in the neighbor base station report, and creates and transmits a base station removing command for removing base stations equal to or greater than a second value from the stored neighbor relation table to the neighbor relation table controller when the statistic value is equal to or greater than the second value.

10. The wireless communication system of claim 7, wherein the statistic value is channel state information between the base station and a neighbor base station.

11. A method of managing a neighbor relation table in a wireless communication system having a self-organized network function, comprising: collecting access failure information of a terminal to a neighbor base station; calculating a statistic value of an access failure rate to the neighbor base station using the collected access failure information; and removing the neighbor base station from the neighbor relation table, in case the calculated statistic value of an access failure rate is less than or equal to a set threshold value.

12. The method of claim 11, wherein the access failure information is hand-over failure information or radio link failure information to the neighbor base station.

13. The method of claim 11, wherein collecting access failure information comprises collecting the access failure information from a terminal or an operation and manager server through a radio resource control (RRC) message.

14. The method of claim 11, further comprising transmitting changed neighbor relation table to a network manager.

15. A base station of managing a neighbor relation table in a wireless communication system having a self-organizing network function, comprising: a storage unit which stores a neighbor relation table; a neighbor relation table controller which controls presence of update in the neighbor relation table; and a neighbor relation adding/removing module which creates a base station adding command or a base station removing command using access failure information to a neighbor base station received from a terminal, and transmits the created command to the neighbor relation table controller.

16. The base station of claim 15, wherein the access failure information is hand-over failure information or radio link failure information to the neighbor base station.

17. The base station of claim 16, wherein neighbor relation adding/removing module calculates a statistic value of an access failure rate to the neighbor base station using the access failure information received from the terminal, and removes the neighbor base station from the neighbor relation table when the calculated statistic value of an access failure rate is less than or equal to a set threshold value.

18. The base station of claim 17, wherein the neighbor relation table controller makes a control to transmit changed neighbor relation table to a network manager.
